(19) United States
(12) Patent Application Publication
(10) Pub. No.: US 2007/0207285 A1
(43) Pub. Date: Sep. 6, 2007

(54) Barrier film

(75) Inventor: Chuan-Yaun Lin, Toufen Township (TW)

Correspondence Address: TROXELL LAW OFFICE PLLC, SUITE 1404, 5205 LEESBURG PIKE, FALLS CHURCH, VA, 22041, US

(73) Assignee: Chuan-Yaun Lin, Miaoli County (TW)

(21) Appl. No.: 11/585,970

(22) Filed: Oct. 25, 2006

(30) Foreign Application Priority Data
Mar. 2, 2006 (TW) 095203449

(51) Int. Cl. B32B 33/00

(52) U.S. Cl. 428/40.1

(57) ABSTRACT

A film is pasted on surface of object to protect it and to decorate it with a grid image. The film has an adhesive layer which make the film capable of being pasted on surface of object for several times.

### FIELD OF THE INVENTION

The present invention relates to a film; more particularly, relates to being pasted on surface of object for several times as being prevented from producing bubbles on pasting and being kept from leaving adhesive on tearing the film off; and obtaining a specific appearance of a grid image.

### DESCRIPTION OF THE RELATED ART

A protecting film pasted on an object, like a film pasted on a display screen of a mobile phone, usually comprises a transparent film and an adhesive layer pasted on a surface of the transparent film. Thus, the protecting film can be pasted on a surface of the object by the adhesive layer to protect the object by the transparent film.

The prior art is pasted on a surface of the object with the whole surface to protect it; so the pasting may not be so smooth that bubbles are produced between the object and the transparent film, which might happen quite often on pasting the protecting film on a mobile phone. In addition, the adhesive layer covers everywhere on the transparent film. Thus, the adhesive layer is fully adhered on the object when pasting the protecting film; and some adhesive may be left on the object when tearing the protecting film off and the adhesive layer may further be destroyed and can not be pasted on the object again. Moreover, a fully covered adhesive layer on the transparent film is not able to be printed with image to decorate the object by pasting the protecting film on the object. Hence, the prior art does not fulfill users' requests on actual use.

### SUMMARY OF THE INVENTION

The main purpose of the present invention is to be pasted on surface of object for several times as being prevented from producing bubbles on pasting and being kept from leaving adhesive on tearing the film off; and to obtain a specific appearance of a grid image.

To achieve the above purpose, the present invention is a barrier film, comprising a transparent plastic film; an adhesive grid layer deposed on a surface of the transparent plastic film; and a release film deposed on a surface of the adhesive grid layer, where the adhesive grid layer is obtained through printing the adhesive grid on a surface of the transparent plastic film with a water-based screening paste by using an aluminum frame coordinated with a mesh fabric, and then hot-drying the surface of the transparent plastic film to obtain a plurality of meshes. Accordingly, a novel barrier film is obtained.

### BRIEF DESCRIPTIONS OF THE DRAWINGS

The present invention will be better understood from the following detailed description of the preferred embodiment according to the present invention, taken in con junction with the accompanying drawings, in which

FIG. 1 and FIG. 2 are the perspective view showing the first preferred embodiment and the second preferred embodiment of the adhesive grid layer;

FIG. 3 is the explosive view of the present invention;

FIG. 4 is the view showing the fabricating of the adhesive grid layer;

FIG. 5 is the view showing the adhesive grid layer obtained; and

FIG. 6 is the view showing the state of use of the present invention.

### DESCRIPTION OF THE PREFERRED EMBODIMENT

The following description of the preferred embodiment is provided to understand the features and the structures of the present invention.

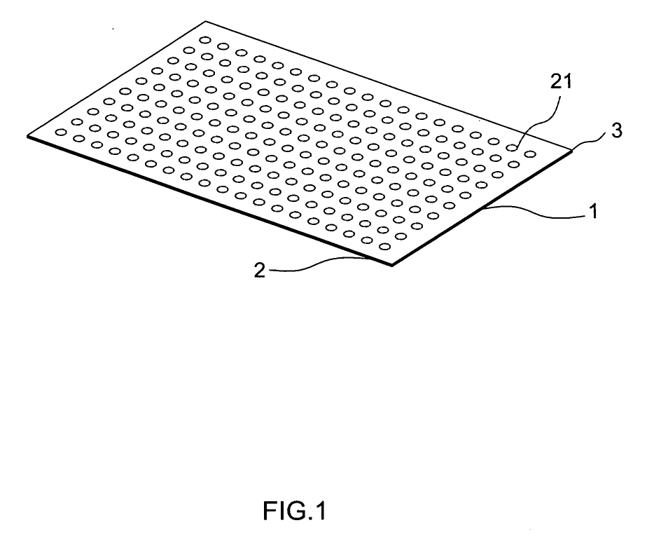

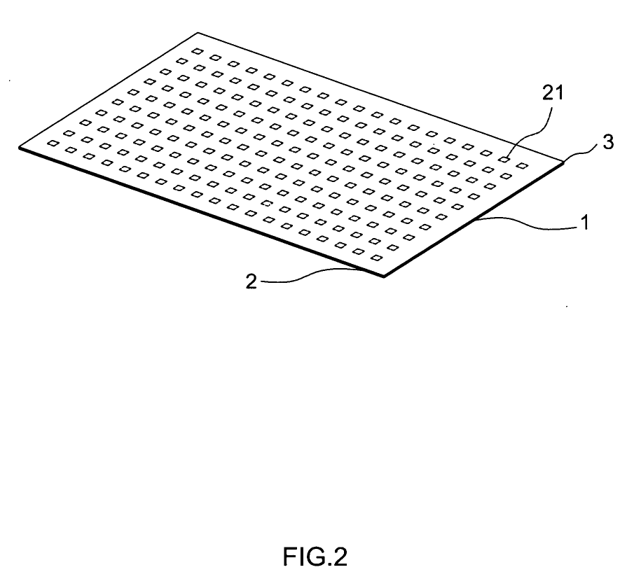

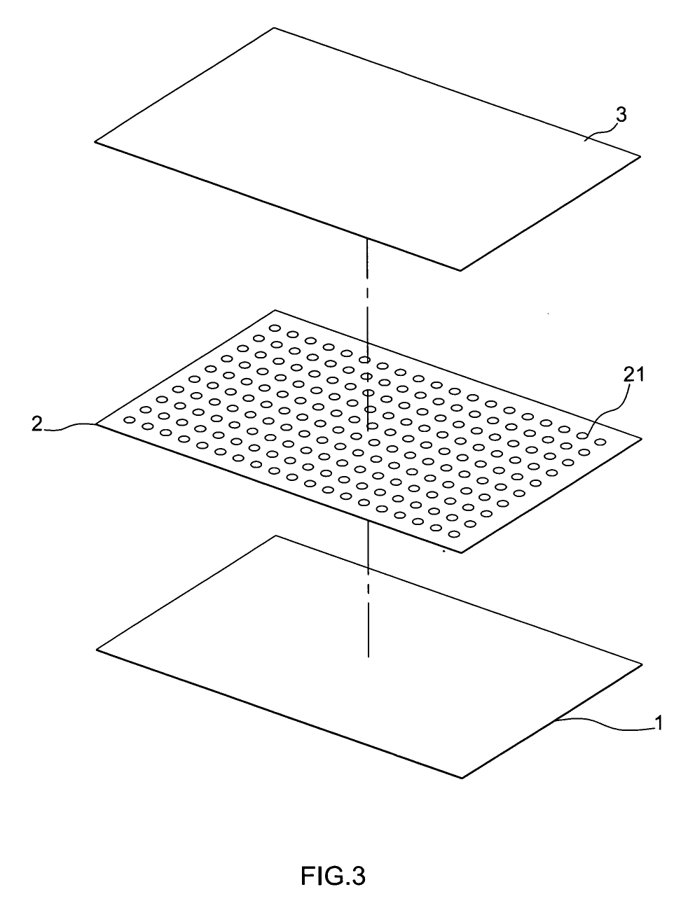

Please refer to FIG. 1, FIG. 2 and FIG. 3, which are a perspective view showing a first preferred embodiment and a second preferred embodiment of the adhesive grid layer; and an explosive view of the present invention. As shown in the figures, the present invention is a barrier film, comprising a transparent plastic film, an adhesive grid layer and a release film, which is used as a film pasted on surface of object for several times as being prevented from producing bubbles on pasting and being kept from leaving adhesive on tearing the film off; and which obtains a specific appearance of a grid image.

The transparent plastic film 1 is a polyester film.

The adhesive grid layer 2 is deposed on a surface of the transparent plastic film 1; and comprises a plurality of meshes 21, where the mesh 21 is a circular mesh (as shown in FIG. 1 or a polygonal mesh (as shown in FIG. 2).

The release film 3 is deposed on a surface of the adhesive grid layer.

Thus, a novel barrier film is obtained with the above structure.

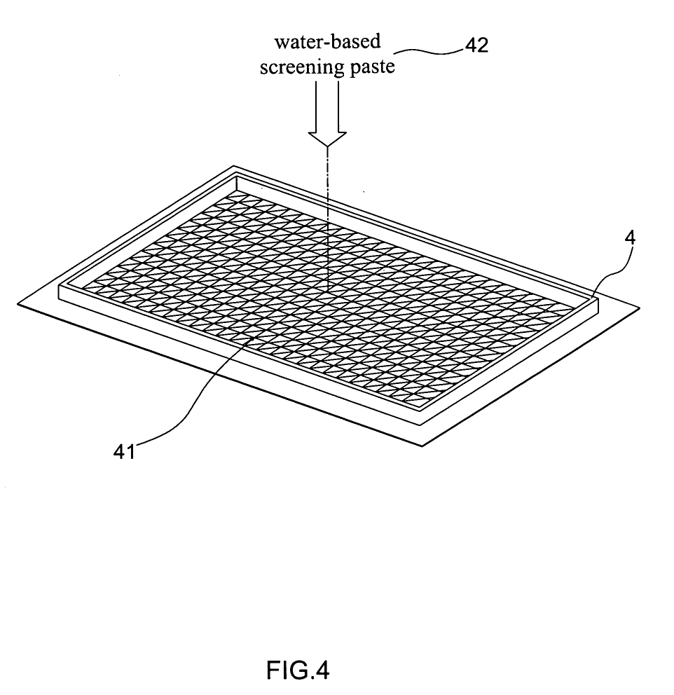

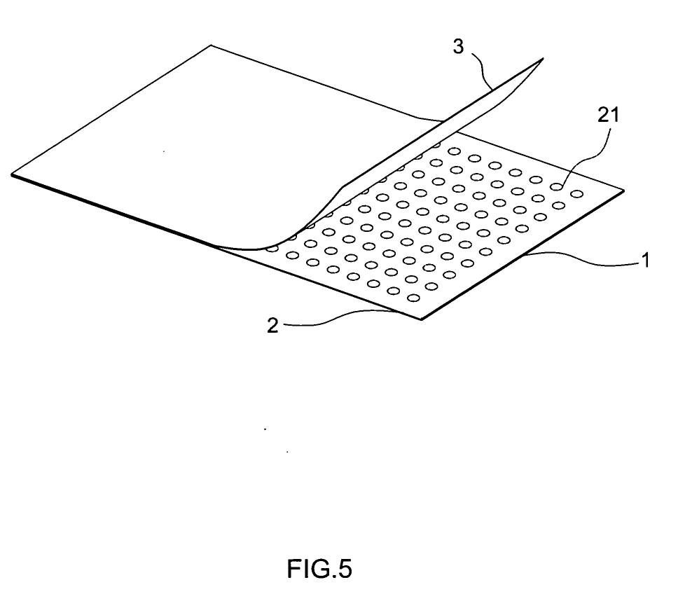

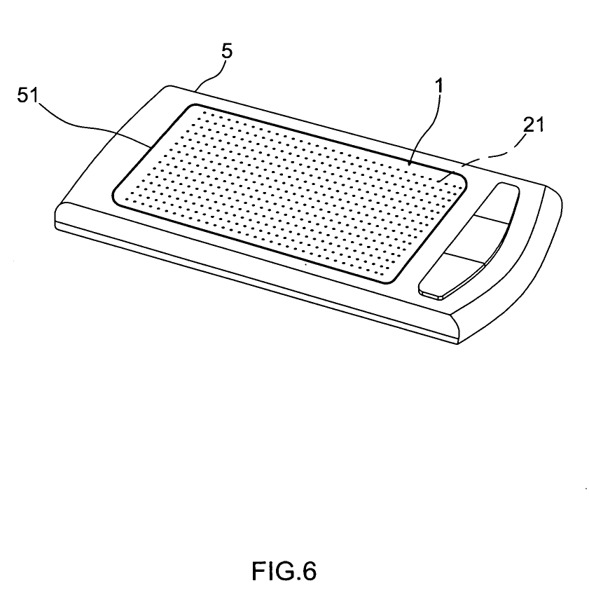

Please refer to FIG. 4, FIG. 5 and FIG. 6, which are views showing a fabricating of an adhesive grid layer, the adhesive grid layer obtained, and a state of use of the present invention. As shown in the figures, when fabricating an adhesive grid layer 2, a screen-print tool is obtained by an aluminum frame 4 coordinated with a mesh fabric 41, where the aluminum frame 4 and the mesh fabric 41 are positioned to form an angle of 90° (degree), 45° or 22.5°; and the mesh fabric 41 has a tension between 20 and 25 newtons. Thus, the adhesive grid layer 2 is obtained through steps of: (a) printing the adhesive grid layer 2 on a surface of the transparent plastic film 1 with a water-based screening paste 42 by using the screen-print tool of the aluminum frame 4 coordinated with the mesh fabric 41; and (b) hot-drying the surface of the transparent plastic film 1 at a temperature of 125 Celsius degrees (° C.) to obtain the adhesive grid layer 2 having a plurality of meshes 21 on the surface of the transparent plastic film 1. The meshes 21 on the surface of the transparent plastic film 1 can be of a various shape and a various interval width by using a various mesh fabric 41. In the end, a release film 3 is covered on a surface of the adhesive grid layer 2 to be heated at a speed of 100 meters per minute; then, the present invention is rolled and stored under a temperature of 25° C. Hence, the present invention can be used by being cut according to a shape of an object or a requirement on actual use.

On an actual use, the present invention is pasted on an object of a various material, like a display window 51 of a mobile phone 5, a notebook computer, an MP3 or MP4 player, an X-BOX player, an LCD display, etc. Take a display window 51 of a mobile phone 5, for example. The release film 3 is torn off and the adhesive grid layer 2 is pasted on the display window 51 of the mobile phone 5 with the surface of the adhesive grid layer 2 having the meshes 21. On pasting the adhesive grid layer 2, bubbles are prevented from producing between the display window 51 and the transparent plastic film 1 because of the meshes 21; and, a protection is thus formed by the transparent plastic film 1 after the pasting. On tearing the adhesive grid layer 2, adhesive is kept from leaving on the display window 51 of the mobile phone 5 because of the meshes 21 too. Thus, the present invention is capable of being posted on surface of object for several times.

To sum up, the present invention is a barrier film, which is used as a film being pasted on surface of object for several times as being prevented from producing bubbles on pasting and being kept from leaving adhesive on tearing the film off; and which obtains a specific appearance of a grid image.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A barrier film, comprising:
a transparent plastic film;
an adhesive grid layer, said adhesive grid layer deposed on a surface of said transparent plastic film; and
a release film, said release film deposed on a surface of said adhesive grid layer,
wherein said adhesive grid layer is obtained through steps of:
printing said adhesive grid layer on said surface of said transparent plastic film with a water-based screening paste by using an aluminum frame coordinated with a mesh fabric; and
hot-drying said surface of said transparent plastic film to obtain a plurality of meshes.

2. The barrier film according to claim 1,
wherein said transparent plastic film is a polyester film.

3. The barrier film according to claim 1,
wherein said plurality of meshes is a plurality of circular meshes.

4. The barrier film according to claim 1,
wherein said plurality of meshes is a plurality of polygonal meshes

5. The barrier film according to claim 1,
wherein said aluminum frame and said mesh fabric are positioned to obtain in between an angle selected from a group consisting of 90° (degree), 45° or 22.5°.

6. The barrier film according to claim 1,
wherein said mesh fabric has a tension between 20 and 25 newtons.

7. The barrier film according to claim 1,
wherein said surface of said transparent plastic film printed with said water-based screening paste is hot-dried at a temperature of 125 Celsius degrees.
